(19) United States
(12) Patent Application Publication
(10) Pub. No.: US 2007/0200032 A1
(43) Pub. Date: Aug. 30, 2007

(54) RADIO FREQUENCY EMITTING HOOK SYSTEM FOR A ROTARY-WING AIRCRAFT EXTERNAL LOAD HANDLING

(76) Inventors: William J. Eadie, Cheshire, CT (US); Mark W. Scott, Bethany, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/565,697

(22) Filed: Dec. 1, 2006

Related U.S. Application Data
(60) Provisional application No. 60/776,264, filed on Feb. 24, 2006.

(51) Int. Cl. B64D 9/00

(52) U.S. Cl. 244/137.4

(57) ABSTRACT

An aircraft load management system that determines the position of an aircraft cargo hook for display to an aircrew. The cargo hook positional information may alternatively or additionally be communicated directly to a flight control system and a winch control system to automate and coordinate flight control inputs with winch operation to actively position the cargo hook. Data transfer from the cargo through a data link system also provides the load management system with exact position of the cargo load connection points even prior to attachment of the cargo hook to the load. The load management system also includes anti-sway algorithms for active load stability inputs to the flight control system and to alter flight control laws and automatically compensate for C.G. excursions.

### BACKGROUND OF THE INVENTION

The present invention claims the benefit of U.S. Provisional Patent Application No. 60/776,284 filed Feb. 23, 2006.

This invention was made with government support under Contract No.:W911W6-05-2-0007 with the United States Army. The government therefore has certain rights in this invention.

The present invention relates to external load operations, and more particularly to a radio frequency emitting hook system for use with Vertical Takeoff and Landing (VTOL) rotary-wing aircraft.

Vertical takeoff and landing (VTOL) rotary-wing aircraft such as, helicopters, co-axial counter rotating aircrafts, tilt-rotors, tilt-wings, etc., are unique in their ability to carry loads externally. Future military forces require enhanced vertical lift capabilities in a compact package. Super heavy lift (SHL) rotary-wing aircraft are generally defined as an aircraft with twice the largest payload of current helicopters. Future requirements are envisioned to be in the range of over 80,000 pounds of payload over a 400 mile range while being shipboard compatible.

External load operations provide a rapid procedure to load, transport, and unload cargo. Frequently, one or more lines having cargo hooks at an end thereof, or a set of slings, are used to attach the cargo to the aircraft for transportation. External load operations are particularly advantageous for situations where ground topography is not conducive to aircraft landing, or where rapid cargo loading and unloading is required. However, as advantageous as this operation is, it may be relatively complicated to execute.

One such complication is cargo hook positioning. That is, the aircraft pilot typically cannot see the external cargo hook. The process of attaching and detaching the cargo hooks to a load generally requires an aircrew member to visually observe through an opening in the bottom of the aircraft fuselage and direct the pilot via an intercom system. Although effective, this process may be relatively time consuming and may be hampered by the time lag between communication of aircraft current position and pilot reaction. Future aircraft designs may not even have an aircrew member available for load observation.

Another complexity of external load operations is the tendency of the load to swing or rotate while in flight. Currently, an aircrew member is responsible to observe the cargo and relay to the pilot via the intercom system, the status of the cargo. Again, generally speaking, verbal descriptions may not be adequate for pilots to stop the cargo from swinging. Other than the pilots “seat of the pants” he has no other useful cues to counter a swinging cargo.

Another complexity of external load operations occurs when a hook is dragged along the ground. Over time, this may result in damage to the cargo hook or create a situation where the cargo hook may become entangled with a ground obstacle.

Accordingly, it is desirable to determine and display to the pilot the actual real-time position of the cargo hook to facilitate the rotary-wing aircraft external load operations.

### SUMMARY OF THE INVENTION

The present invention provides an aircraft load management system that determines the position of an aircraft cargo hook through a wireless communication system. The aircraft load management system calculates in real time the cargo hook position for display upon a multi-function display (MFD) for immediate pilot interpretation and proper flight control response. The cargo hook positional information may also be communicated directly to a flight control system and a winch control system to actively position the cargo hook.

The wireless communication system includes an emitter such as a passive or active Radio Frequency (“RF”) Emitter tag on the cargo hook and a multiple of sensors located on the aircraft. The emitter wirelessly communicates with the sensors such that the load management system calculates the three dimensional position and velocity of the cargo hook through triangulation.

The cargo hook may additionally include other sensors and actuators which communicate with the load management system through the wireless communication system. A wireless actuator remotely operates a load beam of the cargo hook such that the cargo hook may be remotely opened and closed through the wireless communication system. The load beam also interacts with a load sensor such that a weight of the load attached to the cargo hook is imported to the load management system.

An RF data link system communicates with a RFID tag on the load such that cargo data such as cargo type, cargo weight, cargo destination, center of gravity (CG) of the load, load connection points and such like is imported into the load management system through the wireless communication system. Data transfer from the cargo through the RF data link system also provides the load management system with the cargo data even prior to attachment of the cargo hook to the load. The cargo load connection point position are compared to the real time position of the cargo hook such that the difference therebetween is transmitted to the pilot through the display and/or directly to the flight control system and winch system to assist rapid and accurate hook positioning either through pilot control or automatically through auto piloting of the flight control system.

The load management system also includes anti-sway algorithms for active load stability inputs to the flight control system to alter flight control laws and automatically compensate for C.G. excursions especially when the load may not be close to the aircraft underside.

The present invention therefore determines and displays to the pilot the actual real-time position of the cargo hook to facilitate the rotary-wing aircraft external load operations.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1A is a general perspective view of an exemplary rotary-wing aircraft embodiment with an external load for use with the present invention utilizing a 4 point sling system to retain a slung load close to the aircraft underside;

FIG. 1B is a general perspective view of another exemplary rotary-wing aircraft embodiment with an external load for use with the present invention utilizing a conventional slung load system;

FIG. 2 is a schematic block diagram of a an external cargo hook load management system;

FIG. 3A is a representation of an external cargo hook position page of the present invention; and

FIG. 3B is a representation of an external cargo hook position page of the present invention after load attachment.

### DETAILED DESCRIPTION OF THE PREFERRED EMBODIMENT

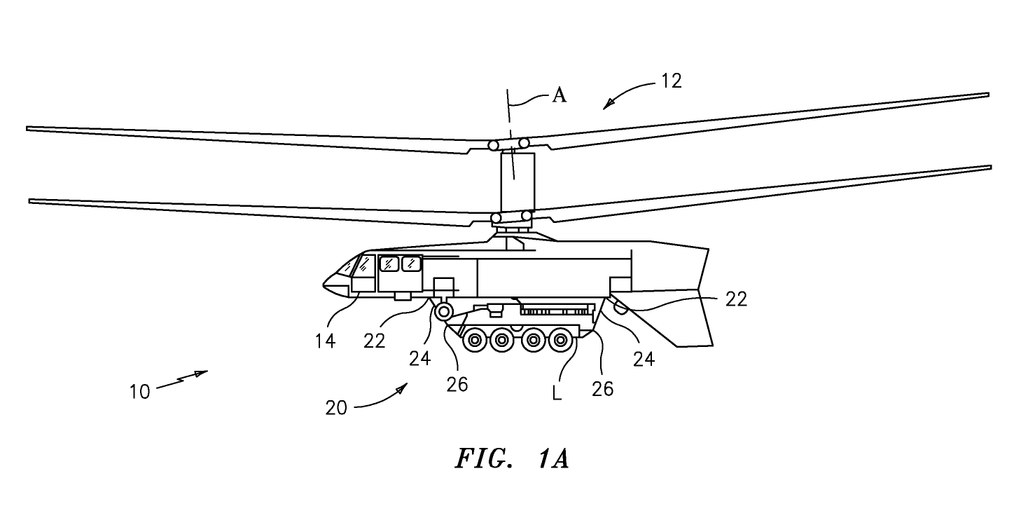

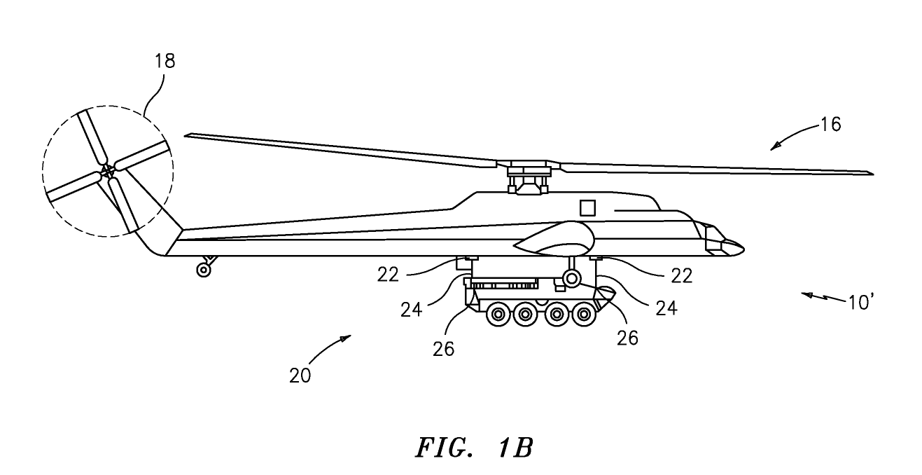

FIG. 1A schematically illustrates a rotary-wing aircraft 10 having a dual, counter-rotating, coaxial rotor system 12 mounted to a fuselage 14. The dual, counter-rotating, coaxial rotor system 12 includes an upper rotor system and a lower rotor system upon an essentially tailless fuselage which facilitates shipboard compatibility. Although a particular type of rotary-wing aircraft configuration is illustrated in the disclosed embodiment, other aircraft such as helicopters 10′ having a single main rotor assembly 16 and an anti-torque rotor 18 (FIG. 1B), flying cranes, tilt-rotor and tilt-wing aircraft will also benefit from the present invention.

An external load is slung from the airframe 14 through an external cargo hook system 20 having a multitude of winches 22 which each deploy a line 24. Each line 24 is connectable to an external load or loads through a cargo hook 26. It should be understood that any number of cables, various mounting orientations, as well as non-cable hook system will also benefit from the present invention.

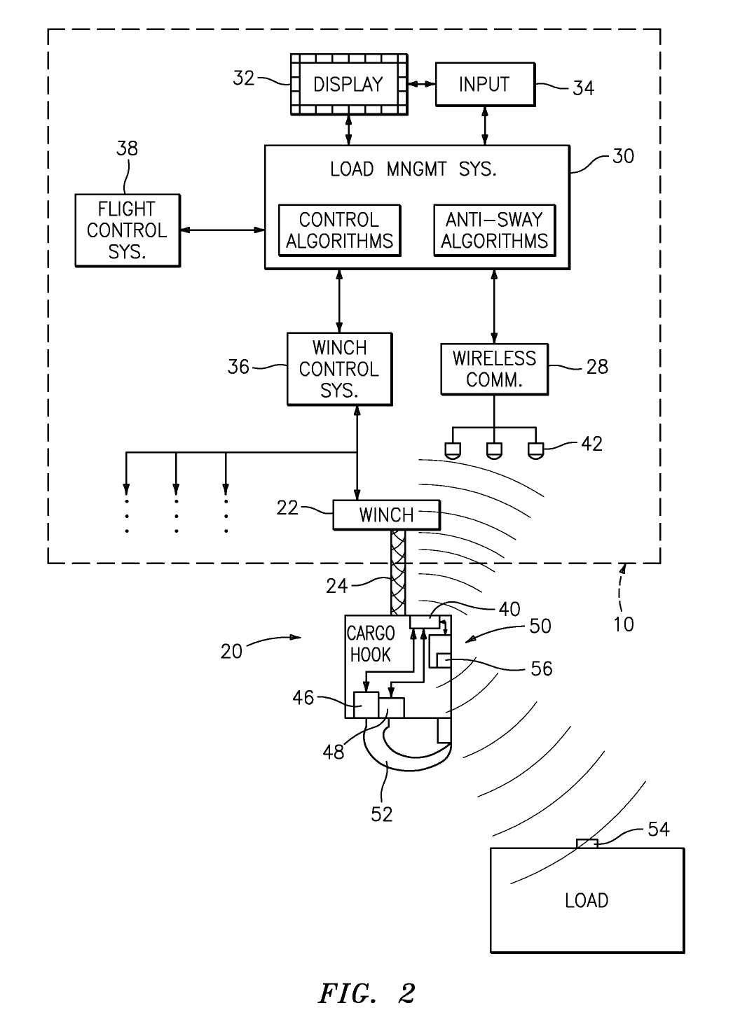

Referring to FIG. 2, a wireless communication system 28 provides communication between the cargo hook system 20 and an aircraft load management system 30 where software calculates in real time the cargo hook position for display upon a display 32 such as a multi-function display (MFD). An input device 34 such as a keyboard, control grip, mouse, track ball, touch screen, or other such control provides for interaction with the load management system 30. The load management system 30 also communicates with a winch control system 36 and an aircraft flight control system 38. For further understanding of other aspects of a load management system and associated components thereof, attention is directed to U.S. patent application Ser. No. 11/455,482 filed Jun. 19, 2006 which is assigned to the assignee of the instant invention and which is hereby incorporated herein in its entirety.

The wireless communication system 28 preferably includes an emitter 40 such as a such as a passive or active Radio Frequency (“RF”) Emitter tag within or upon the cargo hook 26 and a multiple of sensors 42 located on the aircraft 10. It should be understood that various emitters or “tags” will be usable with the present invention and that the system is not limited to only RF communication. The emitter 40 wirelessly communicates with the sensors 42 such that the load management system 30 calculates the three dimensional position and velocity of each cargo hook 26 through, for example, triangulation.

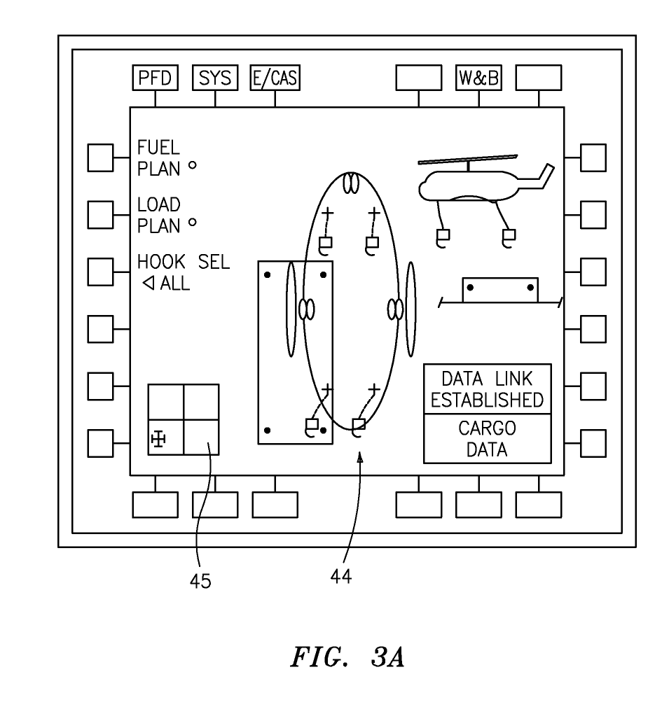

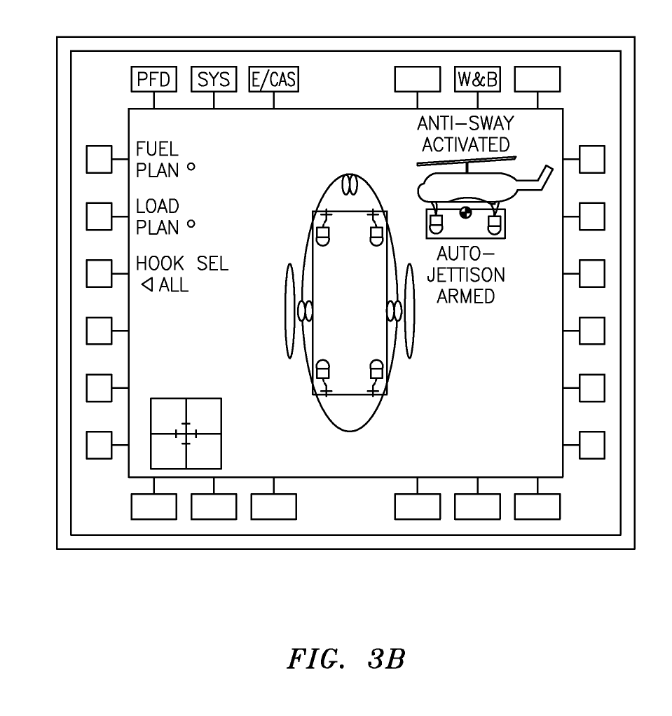

This positional information of the cargo hook 26 is preferably displayed on the display 32 for interpretation and proper flight control response. The cargo hook positional information may be displayed by symbology 44 (FIGS. 3A and 3B) or through command bars 45 on the display 32 as on a flight director to guide pilot flight control inputs. It should be understood that various symbology may be utilized to display the real-time cargo hook, load, and aircraft position. Furthermore, other information such as whether the hook is open or closed, load data and other information related to external load operations may alternatively or additionally be displayed. Alternatively, the cargo hook positional information is communicated directly to the flight control system 38 and winch control system 36 to automate and coordinate flight control inputs to adjust hook position.

There is significant advantage to the knowledge of exactly where each cargo hook 26 is with respect to the aircraft 10. For example, if the real time position and motion (i.e. is still or swinging) of the cargo hook 26 is displayed to the pilot, the pilot can apply proper piloting technique to correct the motion and position of the cargo hook. Furthermore, by display of the position of the cargo hook 26 relative to the aircraft 10, a dragging condition is readily identified by the relative motion of the hook and aircraft.

The cargo hook 26 may additionally include other wireless sensors and actuators which communicate with the load management system 30 through the wireless communication system 28. Preferably, the cargo hook 26 includes a wireless actuator 46, a load sensor 48, and a data link 50. It should be understood that various systems and operations within the cargo hook 26 may utilize the wireless communication system 28 to provide for wireless operation, control and communication between the cargo hook 26 and the load management system 30.

The wireless actuator 46 remotely operates a load beam 52 of the cargo hook 26 such that the cargo hook 26 may be remotely opened and closed through the wireless communication system 28. The load beam 52 preferably interacts with the load sensor 48 such that an actual load attached to the cargo hook 26 is transmitted to the load management system 30 through the wireless communication system 28. The wireless actuator 46 and the load sensor 48 avoid the heretofore necessary communication wire attached along the cable and the potential resultant vulnerability from chaffing, stretching, and fatigue.

The data link system 50 preferably includes an RF data receiver 56 which communicates with a RFID tag 54 on the load such that the load management system 30 will receive cargo data such as cargo type, cargo weight, cargo destination, exact position of load center of gravity (CG), load connection point position and such like. The cargo data is preferably directly imported into the load management system 30 through the wireless communication system 28. Data transfer from the load through the data link system 50 provides the load management system 30 with cargo data such as the exact position of the cargo load connection points even prior to attachment of the cargo hook 26 to the load. The cargo load connection point position can then be compared to the real time position of the cargo hook 26 such that the difference therebetween is transmitted to the pilot through the display 24 and/or directly to the flight control system 38 to assist rapid and accurate cargo hook positioning through pilot control or automatically through auto piloting of the flight control system 38.

In addition, for a cargo hook 26 deployed from a winch 22 on a line 24 the winch control system 36 may be directly controlled by the load management system 30 to automatically reel-in or pay-out the line 24 to position the cargo hook 26 relative to the load. The data link system 50 facilitates attaching and detaching a load located on a ship which may be pitching and heaving. Under these circumstances, the load may be constantly moving with respect to the cargo hook 26. In such a situation, the data link system 50 in combination with the winch control system 36 and the load management system 30 reels-in and pays-out the line 24 to match the motion of the ship, thereby maintaining the cargo hook 26 at the same height relative to the load. Such cargo hook control readily facilitates load connection and improved safety for ship personnel who attach/detach the cargo hook.

One complexity of external load operations is the tendency of the load to swing or rotate while in flight. The load management system 30 preferably includes anti-sway algorithms for active load stability inputs to the flight control system 38 and winch control system 36. Through triangulation of each emitter 40 on each cargo hook 26, the load management system 30 determines the position and motion of the load by determination of the position and motion of each cargo hook 26. Data transfer from the load through the data link system 50 such as load center of gravity is input to the anti-sway algorithms of the load management system 30 to further refine control during flight. The cargo hook 26 position is communicated to the Flight Control System 38 to alter, for example, flight control laws and automatically compensate for C.G. excursions especially when the load may not be close to the aircraft underside. This load swing or rotation is transmitted to the pilot through the display 24 and/or directly to the flight control system 38 and winch control system 36 to control the load through pilot control and/or through auto piloting. Furthermore, should the motion of the load become greater than limits, an automatic release system in communication with the load management system 30 may be activated to release the load and protect the aircraft.

The anti-sway algorithms of the load management system 30 provide a continuous input at or close to the natural pendulum frequency of the load through active control of the winches 22 and the flight control system 38. The anti-sway algorithms operate to swing the load at displacements at pendulum natural frequency 90 degrees out of phase to cause a resonant condition. To stop the load from swinging, small displacements are made at the pendulum natural frequency 180 degrees out of phase. That is, the winch control system 36 is controlled by the load management system 30 through the anti-sway algorithms to provide an output to drive each winch 22 to alter the length of the line 24 to position the load so that oscillations are damped out and the load remains stable. It should be understood that various indices may be utilized to detect movement of the slung load and provide compensation therefore.

The load management system 30 also receives real time flight data and control position inputs from the flight control system. This data enables the load management system 30 to anticipate aircraft attitudes and accelerations to provide proactive load control. This data is used to position the load in response to aircraft flight maneuvers, and thus improve aircraft control. Although the present invention has focused on external load operations, it should be noted that many of the inventive features may apply to other areas as well, such as, for example, rescue winches. Moreover, although the prior discussion has focused on RF-type emitter tags and sensors, it should be noted that other wireless emitters and sensors, such as electromagnetic, light, IR, sound, ultrasonic, etc may likewise be usable.

It should be understood that relative positional terms such as “forward,” “aft,” “upper,” “lower,” “above,” “below,” and the like are with reference to the normal operational attitude of the vehicle and should not be considered otherwise limiting.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An aircraft cargo hook system, comprising:
a cargo hook; and
a wireless system in communication with said cargo hook to determine a position of said cargo hook.

2. The system as recited in claim 1, wherein said wireless system includes one of an emitter system and a sensor system mounted to said cargo hook and the other of said emitter system and said sensor system mounted to the aircraft to determine a position of said cargo hook.

3. The system as recited in claim 2, wherein said emitter system includes a Radio Frequency emitter system.

4. The system as recited in claim 2, wherein said sensor system includes a multiple of sensors to triangulate said position of said cargo hook.

5. The system as recited in claim 1, further comprising a wireless actuator to selectively actuate a load beam of said cargo hook through said wireless system.

6. The system as recited in claim 1, further comprising a wireless load sensor to sense an actual weight on said cargo hook, said wireless load sensor in communication through said wireless system.

7. The system as recited in claim 1, further comprising a wireless data link to communicate load data from a load through said wireless system.

8. The system as recited in claim 1, further comprising an aircraft load management system in communication with said wireless system.

9. The system as recited in claim 8, further comprising a display in communication with said aircraft load management system.

10. The system as recited in claim 9, further comprising a flight control system in communication with said aircraft load management system.

11. The system as recited in claim 10, wherein said aircraft load management system includes an anti-sway algorithm.

12. The system as recited in claim 11, further comprising a winch control system in communication with said aircraft load management system to control a winch connected to said cargo hook in response to said anti-sway algorithm and said flight control system.

13. The system as recited in claim 1, wherein said wireless system includes a laser emitter.

14. A rotary wing-aircraft cargo hook system, comprising:
a winch operable to deploy and retract a cable;
a cargo hook attached to said cable;
a wireless system in communication with said cargo hook;
an aircraft load management system in communication with said wireless system to determine a position of said cargo hook; and
a display in communication with said aircraft load management system to display the position of said cargo hook.

15. The system as recited in claim 14, wherein said aircraft load management system includes an anti-sway algorithm in communication with a flight control system.

16. The system as recited in claim 15, further comprising a winch control system in communication with said aircraft load management system to control said winch during flight in response to said cargo hook.

17. The system as recited in claim 15, further comprising a winch control system in communication with said aircraft load management system to control said winch in response to said anti-sway algorithm and said flight control system relative to a load prior to connection of said cargo hook with the load.

18. A method of controlling a rotary wing-aircraft cargo hook system comprising the steps of:
(A) wirelessly communicating with a cargo hook;
(B) determining a position of the cargo hook with an aircraft load management system; and
(C) displaying the position of the cargo hook.

19. The method as recited in claim 18, further comprising the step of:
(D) controlling a winch to adjust a cable length attached to said cargo hook in response to an anti-sway algorithm in response to said step (A).

20. The method as recited in claim 18, further comprising the step of:
(D) wirelessly communicating load data from a load to the aircraft load management system.

21. The method as recited in claim 18, further comprising the steps of:
(D) wirelessly communicating with a load; and
(E) determining a position of the cargo hook relative the load.

22. The method as recited in claim 21, further comprising the steps of:
(F) controlling a position of the cargo hook.

23. The method as recited in claim 22, wherein said step (F) further comprises the steps of:
(a) controlling a winch control system to reel-in and pay-out a cable attached to the cargo hook.

24. The method as recited in claim 22, wherein said step (F) further comprises the steps of:
(a) communicating the position of the cargo hook from the aircraft load management system to a flight control system;
(b) controlling the position of the cargo hook by positing the aircraft.
